(19) United States
(12) Patent Application Publication
(10) Pub. No.: US 2019/0239994 A1
(43) Pub. Date: Aug. 8, 2019

(54) WHITE LIGHT CONVERTERS

(71) Applicant: Ultradent Products, Inc., South Jordan, UT (US)

(72) Inventors: Neil Thomas Jessop, Sandy, UT (US); Craig Arnold McIntier, Layton, UT (US)

(21) Appl. No.: 15/887,732

(22) Filed: Feb. 2, 2018

(51) Int. Cl. A61C 13/15; F21V 9/32; F21V 5/10; F21V 17/10

(52) U.S. Cl. CPC A61C 19/004; F21V 9/32; F21W 2131/202; F21V 17/105; F21V 5/10

(57) ABSTRACT

An optical converter assembly includes a housing, a securing mechanism, and a light converter. The housing defines a first opening that receives part of a light-emitting portion of a dental curing light when the housing is selectively secured relative to the light-emitting portion of the dental curing light. The securing mechanism selectively retains the housing relative to the light-emitting portion. The light converter is comprised of a phosphor material and secured relative to the housing such that input light having a first set of wavelengths and radiant power emitted by the dental curing light is received. The light converter converts the input light to an output light having a second set of wavelengths and radiant power and to emit the output light. The input light includes a blue light and an ultraviolet light that polymerizes a dental material. The output light may be a white light.

### BACKGROUND

### Field of the Invention

The present invention generally relates to dental instruments and, in particular, to light converters that may be implemented with dental curing lights.

### Description of Related Art

In some dental procedures, curing lights may be implemented to cure photosensitive materials. For instance, light-curable substances may be used in dental restoration processes (e.g., filling cavities). The light-curable substances may be introduced into a decayed or damaged portion of a tooth. The light-curable substance may then be exposed to light emitted by the curing light, which may cure and harden the light-curable substances. Some curing lights utilize light emitting diodes (LEDs). The LEDs may emit light that is a combination of the ultraviolet light and blue light.

Inspection of portions of mouths of patients may be conducted by dental healthcare providers. The mouths of the patients may be relatively dark. Accordingly, the inspections may benefit from introduction of light into the mouths of the patients. In addition, the inspections may benefit from white light, which may enable a more thorough inspection than can be conducted with a colored light.

The subject matter claimed herein is not limited to embodiments that solve any disadvantages or that operate only in environments such as those described. Rather, this background is only provided to illustrate one example technology area where some embodiments described herein may be practiced.

### BRIEF SUMMARY

A need therefore exists for a dental instrument that eliminates or diminishes the above-described disadvantages and problems.

One aspect is an optical converter assembly that may be implemented with dental curing lights. The optical converter assembly may include a housing, a securing mechanism, and a light converter. The housing may define a first opening at a first end. The first opening may be configured for receipt of a portion of a light-emitting portion of a dental curing light when the housing is selectively secured relative to the light-emitting portion of the dental curing light. The securing mechanism may be configured to selectively retain the housing relative to the light-emitting portion. The light converter may be comprised of a phosphors material. The light converter may be secured relative to the housing such that an input light having a first set of wavelengths and a first radiant power emitted by the dental curing light is received by the light converter. The light converter may be configured to convert the input light to an output light having a second set of wavelengths and a second radiant power and to emit the output light. The input light may include a blue light and an ultraviolet light configured to polymerize a dental material and the output light may be substantially a white light. The first set of wavelengths of the input light may include wavelengths in a range of about 385 nanometers (nm) to about 515 nm, a range of about 440 nm to about 480 nm, or a range of about 395 nm to about 480 nm. In detail, the first set of wavelengths of the input light may include a first peak at about 405 nm, a second peak at about 440 nm, and a third peak at about 460 nm and the second set of wavelengths of the output light may include a first peak at 405 nm, a second peak at about 460 nm, and a blended spectrum with wavelengths greater than about 460 nm. The input light may include a radiant power of about 1067 milliwatt (mW) and the output light includes a second radiant power of about 173.7 mW. The light converter may be constructed of a polymer sheet with the phosphors material arranged in a phosphors matrix disposed on the polymer sheet. The polymer sheet may include polyethylene terephthalate (PET). The output light includes a correlated color temperature between about 5400 Kelvins (K) to about 5600 K. The securing mechanism may include a magnetic element that is positioned within the housing. The magnetic element may be configured for magnetic retention of the housing relative to the light-emitting portion of the dental curing light. The housing may define a second opening at a second end, which is opposite the first end. The housing may include a conical portion that includes the second opening and a cylindrical portion that extends from the first end to the conical portion. The magnetic element may extend around a circumferential inner surface of the cylindrical portion. The light converter may be positioned between the magnetic element and the second opening. The optical converter assembly may include a lens element. The lens element may include a conical portion and a cylindrical portion that is coupled to a first end of the conical portion. The light converter may be adhered to a surface of a second end of the conical portion. The housing may define a second opening at a second end, which may be opposite the first end. The housing may include a conical portion that includes the second opening and a cylindrical portion that extends from the first end to the conical portion. The magnetic element may extend around a circumferential inner surface of the cylindrical portion.

Another aspect is a dental instrument assembly that may include a dental curing light and an optical converter assembly. The optical converter assembly may include a housing, a securing mechanism, and a light converter. The housing may define a first opening at a first end. The first opening may be configured for receipt of a portion of a light-emitting portion of a dental curing light when the housing is selectively secured relative to the light-emitting portion of the dental curing light. The securing mechanism may be configured to selectively retain the housing relative to the light-emitting portion. The light converter may be comprised of one or more phosphor materials that may be arranged in a phosphors matrix. The light converter may be secured relative to the housing such that an input light having a first set of wavelengths and a first radiant power emitted by the dental curing light is received by the light converter. The light converter may be configured to convert the input light to an output light having a second set of wavelengths and a second radiant power and to emit the output light. The input light may include a blue light and an ultraviolet light configured to polymerize a dental material and the output light may be substantially a white light. The first set of wavelengths of the input light may include wavelengths in a range of about 385 nm to about 515 nm, a range of about 440 nm to about 480 nm, or a range of about 395 nm to about 480 nm. In detail, the first set of wavelengths of the input light may include a first peak at about 405 nm, a second peak at about 440 nm, and a third peak at about 460 nm and the second set of wavelengths of the output light may include a first peak at 405 nm, a second peak at about 460 nm, and a blended spectrum with wavelengths greater than about 460 nm. The input light may include a radiant power of about 1067 mW and the output light includes a second radiant power of about 173.7 mW. The light converter may be constructed of a polymer sheet. The polymer sheet may include PET. The phosphors matrix may be disposed on the PET sheet. The output light includes a correlated color temperature between about 5400 K to about 5600 K. The securing mechanism may include a magnetic element that is positioned within the housing. The magnetic element may be configured for magnetic retention of the housing relative to the light-emitting portion of the dental curing light. The housing may define a second opening at a second end, which is opposite the first end. The housing may include a conical portion that includes the second opening and a cylindrical portion that extends from the first end to the conical portion. The magnetic element may extend around a circumferential inner surface of the cylindrical portion. The light converter may be positioned between the magnetic element and the second opening. The optical converter assembly may include a lens element. The lens element may include a conical portion and a cylindrical portion that is coupled to a first end of the conical portion. The light converter may be adhered to a surface of a second end of the conical portion. The housing may define a second opening at a second end, which may be opposite the first end. The housing may include a conical portion that includes the second opening and a cylindrical portion that extends from the first end to the conical portion. The magnetic element may extend around a circumferential inner surface of the cylindrical portion.

Still another aspect is an optical converter assembly that is selectively secured relative to a dental curing light. The optical converter assembly may include a housing, a magnetic element, and a light converter. The housing may define an internal volume between a first opening at a first end and a second opening at a second end. The first opening and a first portion of the internal volume may be configured for receipt of a portion of a light-emitting portion of a curing light such that a curing light of the dental curing light is aligned with the first opening and the second opening. The magnetic element may be positioned within the internal volume of the housing. The magnetic element may be configured for magnetic retention of the housing relative to the curing light of the dental curing light. The light converter may be positioned in the internal volume between the first opening and the second opening such that input light emitted from the curing light enters the internal volume and is received by the light converter. The light converter may be constructed of one or more phosphor materials that may be arranged in a phosphors matrix. The light converter may be constructed such that in response to receipt of the input light, the light converter emits an output light via luminescence that is a white light. The phosphors matrix may be encapsulated between polymer sheets. The input light may have a first set of wavelengths that includes a first wavelength of about 405 nm, a second wavelength of about 440 nm, and a third wavelength of about 460 nm. The output light may have a second set of wavelengths that includes a first wavelength of about 405 nm and a second wavelength of about 460 nm. The third wavelength of the input light is converted to a blended spectrum above about 460 nm. The input light may have a first radiant power of about 1067 mW. The light converter may attenuate the first radiant power such that the output light has a radiant power of about 173.7 mW. The input light may include one or more wavelengths with a range of about 385 nm to about 515 nm; a range of about 440 nm to about 480 nm; or a range of about 395 nm to about 480 nm. The output light may include a correlated color temperature between about 5400 K to about 5600 K. The optical converter assembly may include a lens element that is partially positioned in the housing. The lens element may include a conical portion and a cylindrical portion that is coupled to a first end of the conical portion. The light converter may be adhered to a surface of a second end of the conical portion. The output light may be directed by the cylindrical portion. The housing may include a conical portion that includes the second opening and a cylindrical portion that extends from the first end to the conical portion and the magnetic element may include a magnetic ring that extends around a circumferential inner surface of the cylindrical portion.

These and other aspects, features and advantages of the present invention will become more fully apparent from the following brief description of the drawings, the drawings, the detailed description of preferred embodiments and appended claims.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

The appended drawings contain figures of exemplary embodiments to further illustrate and clarify the above and other aspects, advantages and features of the present invention. It will be appreciated that these drawings depict only exemplary embodiments of the invention and are not intended to limit its scope. Additionally, it will be appreciated that while the drawings may illustrate preferred sizes, scales, relationships and configurations of the invention, the drawings are not intended to limit the scope of the claimed invention. The invention will be described and explained with additional specificity and detail through the use of the accompanying drawings in which:

FIG. 1 illustrates a first exemplary dental instrument assembly;

FIG. 2 illustrates a second optical converter that may be implemented in the first dental instrument assembly of FIG. 1;

FIG. 3 illustrates a second exemplary dental instrument assembly;

FIG. 4 illustrates a second optical converter that may be implemented in the second dental instrument assembly of FIG. 3;

FIGS. 5A and 5B illustrate a first example light converter that may be implemented in the optical converters of FIGS. 2 and 4;

FIGS. 5C and 5D illustrate a second example light converter that may be implemented in the optical converters of FIGS. 2 and 4;

FIG. 6 is a plot of an example phosphor report that may be generated from the first light converter of FIGS. 5A and 5B;

FIG. 7 is a plot of another example phosphor report that may be generated from the second light converter of FIGS. 5C and 5D;

FIG. 8 illustrates an example plot of a relationship between radiant power and wavelength of an input light of the dental instrument assemblies of FIGS. 1 and 3; and

FIG. 9 illustrates an example plot of a relationship between radiant power and wavelength of an output light of the dental instrument assemblies of FIGS. 1 and 3.

### DETAILED DESCRIPTION OF SOME EMBODIMENTS

The following exemplary embodiments are generally described in connection with dental curing lights and light converters implemented with the dental curing lights. The principles of the present invention, however, are not limited to dental curing lights. In particular, the principles of the present invention may be implemented in other medical or dental devices. In addition, it will be understood that, with the benefit of the present disclosure, the light converters and/or the dental curing lights disclosed herein can have a variety of shapes, sizes, configurations, and arrangements. Furthermore, the invention is described connected with a dental curing operation. However, the invention may be successfully used in connection with other types of medical or dental procedures.

Embodiments of the light converters and systems implementing light converters are described with reference to accompanying figures in which items and features labelled with the same item number include a similar structure and function unless described otherwise.

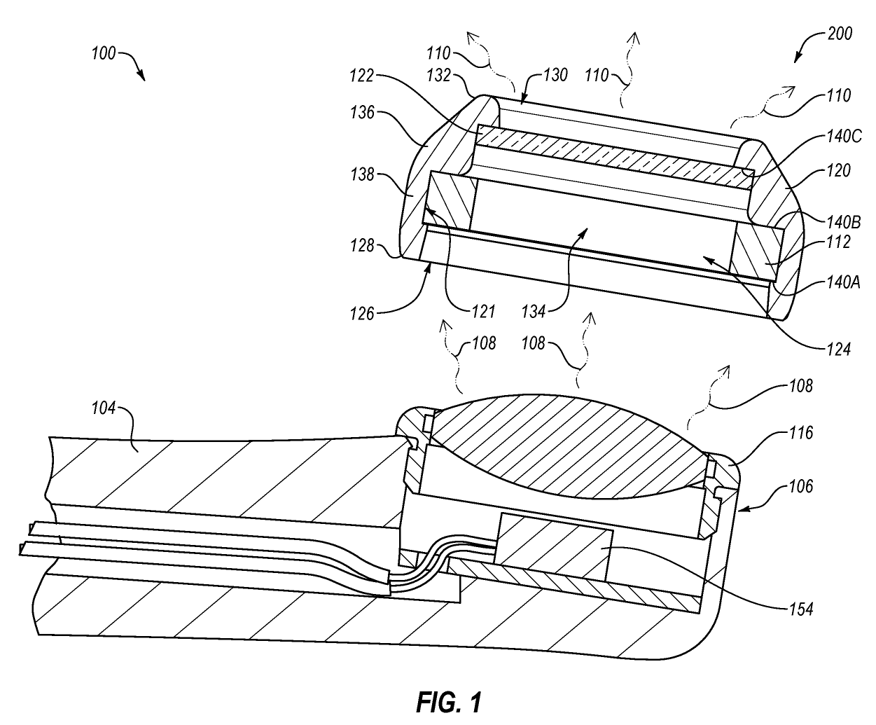

FIG. 1 illustrates a first exemplary dental instrument assembly 100 (hereinafter, “first assembly 100”) according to at least one embodiment of the present disclosure. FIG. 1 depicts a sectional view of the first assembly 100. The first assembly 100 may be configured to emit an output light 110. For example, the first assembly 100 may include a first optical converter 200 that is configured to convert an input light 108 emitted from a dental curing light 104 to the output light 110.

The output light 110 is a white light or substantially a white light. The term “white light”, as used in the present disclosure, refers to light having a combination of wavelengths that stimulates red, green, and blue receptors of the human eye to create the appearance or perception of white to an observer. For example, “white light” may include light having a color temperature in a range of from about 1500 K and about 20000 K, in a range of from about 2000K and about 8000 K, in a range of from about 2700 K to about 6500 K, or in another color temperature range that is suitable for producing white light. The white light may be used by a dental professional to illuminate a portion of a mouth of a patient. For instance, during a dental procedure, portions of the mouth of a patient may be dark, which may make evaluation of the portions difficult. The first assembly 100 is configured to emit the output light 110 that illuminates the portions, which may enable or assist in diagnosis and/or evaluation of dental issues, such as caries or cracks in teeth.

In FIG. 1, the first optical converter 200 is depicted exploded from the dental curing light 104. In some embodiments, the dental curing light 104 may be configured as described in U.S. patent application Ser. No. 13/133,129, which is incorporated herein by reference in its entirety. In some embodiments, the dental curing light 104 may include a VALO® curing light (commercially available from Ultradent Products, Inc.) or another suitable dental curing light.

The first optical converter 200 is configured to be selectively secured or attached relative to a light-emitting portion 106 of the dental curing light 104. Selective securement or attachment between the first optical converter 200 and the light-emitting portion 106 may facilitate use of the first assembly 100 by enabling a user to readily attach and remove the second optical converter 200 from the dental curing light 104 to change the output of the dental curing light 104. For instance, the dental curing light 104 may be used to polymerize a dental material in a mouth of a patient. During a polymerizing process and/or following the polymerizing process, a dental professional may secure the first optical converter 200 to the light-emitting portion 106. The dental professional may then illuminate the mouth of the patient, which may enable evaluation of the dental material. The dental professional may then remove the first optical converter 200 from the light-emitting portion 106 and continue the polymerizing process.

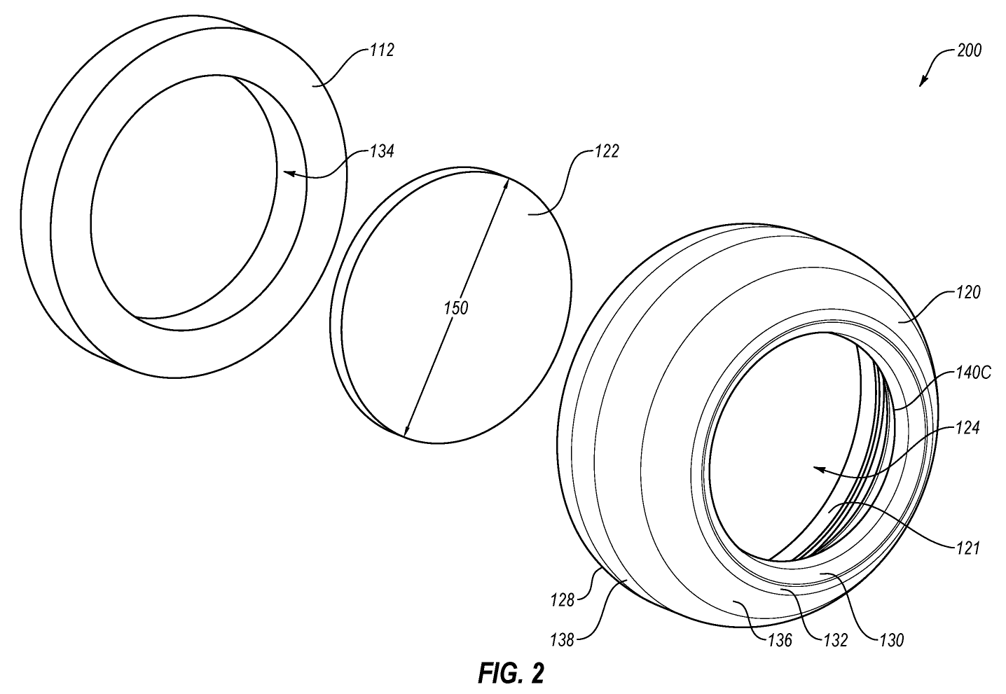

FIG. 2 illustrates an exemplary embodiment of the first optical converter 200, according to at least one embodiment of the present disclosure. FIG. 2 depicts an exploded perspective view of the first optical converter 200. For example, the first optical converter 200 may include a securing mechanism 112, a housing 120, and a light converter 122, which are depicted exploded from one another in FIG. 2.

With combined reference to FIGS. 1 and 2, the securing mechanism 112 is used to selectively retain the first optical converter 200 to the light-emitting portion 106. The securing mechanism 112 may include any mechanism that enables the selective securement between the first optical converter 200 and the light-emitting portion 106. For instance, in the depicted embodiment, the securing mechanism 112 may include a magnetic element. The magnetic element is configured for magnetic retention of the first optical converter 200 to a ferrite ring 116 of the light-emitting portion 106. A magnetic force between the first optical converter 200 and the ferrite ring 116 may be sufficient to secure the first optical converter 200 relative to the dental curing light 104 in most or all orientations (e.g., sufficient to overcome gravity). The first assembly 100 may accordingly be held in any orientation without the first optical converter 200 being displaced relative to the dental curing light 104.

In the depicted embodiment, the magnetic element includes a magnetic ring. The magnetic ring may extend around a circumferential inner surface 121 of the housing 120. Additionally, the magnetic ring may define an opening 134. The opening 134 may be configured such that the input light 108 may exit the light-emitting portion 106 and pass through the magnetic ring. In some embodiments, the magnetic element may include a portion of a magnetic ring such as a magnetic arc. Alternatively, the magnetic element may include a rectangular magnetic feature or another suitable magnetic feature.

In some embodiments, the securing mechanism 112 may include another physical coupling configured to retain the first optical converter 200 to the dental curing light 104. For instance, the first optical converter 200 may include a threaded fastener, which may be mechanically coupled to a threaded portion of the dental curing light 104. Additionally or alternatively, the securing mechanism 112 may include a press-fit coupling, an adhesive coupling, a retainer, or a sleeve that extends over a head 118 of the curing light, or another suitable securing mechanism 112.

In the embodiment of FIGS. 1 and 2, the securing mechanism 112 is positioned within an internal volume 124 defined by the housing 120. The internal volume 124 is defined between a first opening 126 at a first end 128 and a second opening 130 at a second end 132. The first end 128 is opposite the second end 132. In some embodiments, the internal volume 124 may be configured such that when the first optical converter 200 is retained relative to the dental curing light 104, a portion of the light-emitting portion 106 is positioned within the internal volume 124. Additionally, in these and other embodiments, when the first optical converter 200 is retained relative to the dental curing light 104, the first end 128 may extend over the portion of the light-emitting portion 106 positioned in the internal volume 124.

The housing 120 may include a conical portion 136 that includes the second opening 130 and a cylindrical portion 138 that extends from the first end 128 to the conical portion 136. The housing 120 defines the internal volume 124 that may include one or more step features 140A, 140B, and 140C (generally, step feature 140 or step features 140). The step features 140 are defined on an internal wall of the housing 120. The step features 140 may position, at least partially, the light converter 122 and/or the securing mechanism 112 in the internal volume 124. For instance, in the depicted embodiment, the securing mechanism 112 may be positioned between the first step feature 140A and the second step feature 140B. Additionally, the light converter 122 may be positioned between the magnetic ring and the second opening 130 and may be positioned against the third step feature 140C. The housing 120 may include an opaque or a solid structure that prohibits or substantially prohibits the output light 110 from being emitted from the housing 120.

The light converter 122 may be positioned in the internal volume 124 of the housing 120. The light converter 122 may be secured in the internal volume 124. For instance, the light converter 122 may be secured against the third step feature 140C. The light converter 122 may be substantially disk-shaped. The light converter 122 may include a diameter 150. The diameter 150 of the light converter 122 may be greater than a diameter of the opening 134 defined by the magnetic ring.

Accordingly, the input light 108 may propagate through a portion of the internal volume 124 (e.g., between the light converter 122 and the first opening 126) and interface with the light converter 122. The light converter 122 may receive the input light 108 and emit the output light 110. The output light 110 may propagate from the first optical converter assembly 200 through the second opening 130.

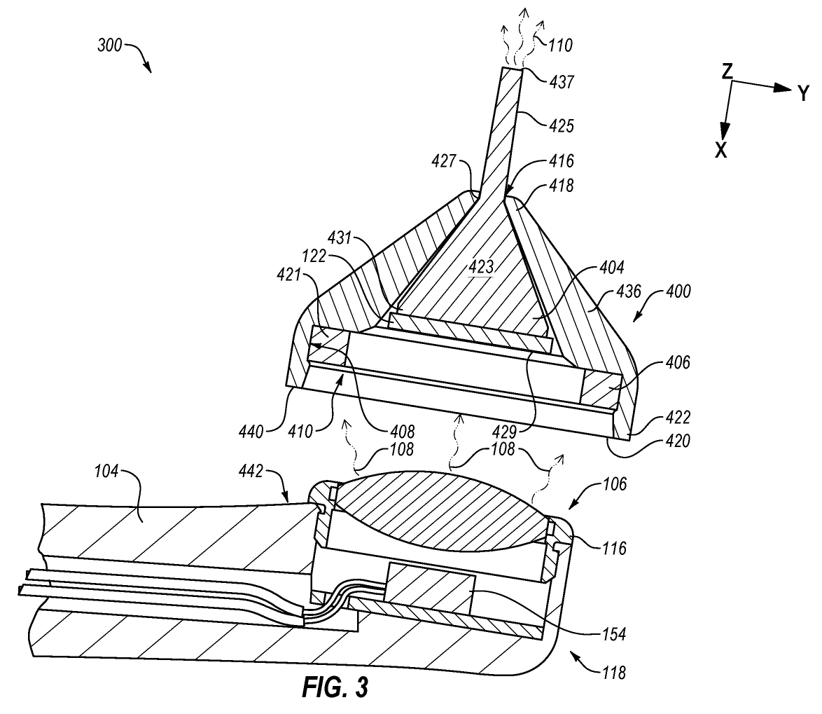

FIG. 3 illustrates a second exemplary dental instrument assembly 300 (hereinafter, “second assembly 300”) according to at least one embodiment of the present disclosure. FIG. 3 depicts a sectional view of the second assembly 300. Similar to the first assembly 100, the second assembly 300 may be configured to emit the output light 110.

The second assembly 300 may include a second optical converter 400. The second optical converter 400 may be configured to convert the input light 108 emitted from the dental curing light 104 to the output light 110. In addition, the second optical converter 400 may be configured to focus or otherwise direct the output light 110. For instance, the second optical converter 400 may be configured to guide the output light 110 to a particular portion of a mouth of a patient.

In FIG. 3, the second optical converter 400 is depicted exploded from the dental curing light 104. The second optical converter 400 is configured to be selectively secured or attached relative to the light-emitting portion 106 of the dental curing light 104. Selective securement or attachment between the second optical converter 400 and the light-emitting portion 106 may facilitate use of the second assembly 300 by enabling a user to readily attach and remove the second optical converter 400 from the dental curing light 104 to change the output of the dental curing light 104.

For instance, the dental curing light 104 may be used to polymerize a dental material that may be used in a dental procedure in a mouth of a patient. During a polymerizing process and/or following the polymerizing process, a dental professional may secure the second optical converter 400 to the light-emitting portion 106. The dental professional may then illuminate the mouth of the patient, which may enable evaluation of the dental material. The dental professional may then remove the second optical converter 400 from the light-emitting portion 106 and continue the polymerizing process.

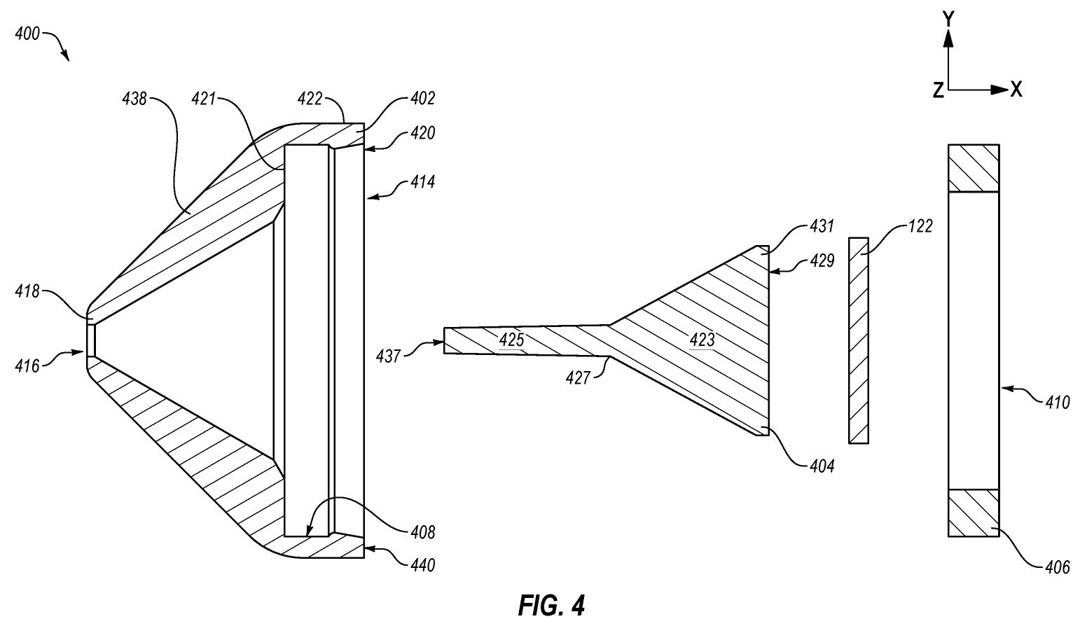

FIG. 4 illustrates an exemplary embodiment of the second optical converter 400, according to at least one embodiment of the present disclosure. FIG. 4 depicts a sectional side view of the second optical converter 400. For example, the second optical converter 400 includes a securing mechanism 406, a housing 402, a lens element 404, and the light converter 122. The securing mechanism 406, the housing 402, the lens element 404, and the light converter 122 are depicted exploded from one another in an x-direction.

With combined reference to FIGS. 3 and 4, the securing mechanism 406 may be used to selectively retain the second optical converter 400 to the light-emitting portion 106 of the curing light 104. The securing mechanism 406 may include any mechanism that enables the selective securement between the second optical converter 400 and the light-emitting portion 106.

For instance, in the depicted embodiment, the second optical converter 400 may include a magnetic element. The magnetic element is configured for magnetic retention of the second optical converter 400 to the ferrite ring 116 of the light-emitting portion 106. A magnetic force between the second optical converter 400 and the ferrite ring 116 may be sufficient to secure the second optical converter 400 relative to the dental curing light 104 in most or all orientations (e.g., sufficient to overcome gravity). The second assembly 300 may accordingly be held in any orientation without the second optical converter 400 becoming displaced relative to the dental curing light 104.

In the depicted embodiment, the magnetic element includes a magnetic ring that also acts as the securing mechanism 406. The magnetic ring may be positioned in the housing 402. The magnetic element may extend around a circumferential inner surface 408 of the housing 402. Additionally, the magnetic ring may define an opening 410. The opening 410 may be configured such that the input light 108 may exit the light-emitting portion 106 and pass through the magnetic ring to contact the light converter 122.

In some embodiments, the securing mechanism 406 may include another physical coupling that is configured to retain the second optical converter 400 to the dental curing light 104. For instance, the second optical converter 400 may include a threaded fastener, which may be mechanically coupled to a threaded portion of the dental curing light 104. Additionally or alternatively, the securing mechanism 406 may include a press-fit coupling, an adhesive coupling, a retainer, or a sleeve that extends over the head 118 of the dental curing light 104, or another suitable securing mechanism 406.

In the embodiment of FIGS. 3 and 4, the securing mechanism 406 is positioned within the internal volume 414 (FIG. 4) defined by the housing 402. The internal volume 414 is defined between a first opening 420 at a first end 422 and a second opening 416 at a second end 418. The first end 422 is opposite the second end 418.

In some embodiments, the internal volume 414 may be configured such that when the second optical converter 400 is retained relative to the dental curing light 104, a portion of the light-emitting portion 106 is positioned within the internal volume 414. For example, when the second optical converter 400 is retained relative to the dental curing light 104, a bottom edge 440 at the first end 422 may contact or be adjacent to a light surface 442 that surrounds at least a portion of the light-emitting portion 106. Additionally, in these and other embodiments, when the second optical converter 400 is retained relative to the dental curing light 104, the first end 422 may extend over the portion of the light-emitting portion 106 positioned in the internal volume 414.

The housing 402 of the second optical converter 400 may include a conical portion 436 that includes the second opening 416 and a cylindrical portion 438 that extends from the first end 422 to the conical portion 436. The second opening 416 of the housing 402 may be smaller than the second opening 130 of the housing 120 described above. The housing 402 may include an opaque or a solid structure that prohibits or substantially prohibits the output light 110 from being emitted from the housing 402. The internal volume 414 may include a step feature 421 that may be defined on an internal wall of the housing 402. The securing mechanism 406 may be positioned against the step feature 421 when the second optical converter 400 is assembled.

The lens element 404 includes a conical portion 423 and a cylindrical portion 425. The cylindrical portion 425 is coupled to or integrally formed at a first end 427 to the conical portion 423. The lens element 404 may be at least partially positioned in the housing 402 when the second optical converter 400 is assembled. For instance, in FIG. 3, the lens element 404 is depicted positioned in the housing 402. When positioned in the housing 402, the cylindrical portion 425 or a portion thereof may extend from and be external from the housing 402. Accordingly, the output light 110 may be optically transmitted through the conical portion 423, which may focus the output light 110 to the cylindrical portion 425. The output light 110 may be propagated through the cylindrical portion 425. A substantially portion of the output light 110 may exit the cylindrical portion 425 at an end 437 of the cylindrical portion 425.

The light converter 122 may be positioned in the second optical converter 400. The light converter 122 may be configured to convert the input light 108 to the output light 110. The light converter 122 may be arranged such that the input light 108 is converted to the output light 110 prior to entry into the lens element 404. For example, in the depicted embodiment, the light converter 122 may be adhered or otherwise attached to a surface 429 of a second end 431 of the conical portion 423. Accordingly, the input light 108 that is emitted from the curing light 104 may enter the light converter 122. The light converter 122 may convert the input light 108 and emit the output light 110 through the lens element 404. The output light 110 enters the conical portion 423 and is directed to the cylindrical portion 425. The output light 110 may then exit the cylindrical portion 425 at the end 437 of the cylindrical portion 425

With combined reference to FIGS. 1-4, the light converter 122 may include one or more phosphor materials (i.e., photoluminescent materials). For example, the light converter 122 may be comprised of a phosphors matrix including a plurality of phosphor particles dispersed or arranged in a matrix. The phosphors material of the light converter 122 may include a specific combination of phosphors that are configured to absorb at least a portion of the input light 108 and to convert and reemit the absorbed input light 108 to generate the output light 110. The output light 110 emitted from the light converter 122 may include light emitted by the phosphor materials of the light converter 122 and may include any portion of the input light 108 that passes through the light converter 122 without being converted by the phosphor materials. Conversion of the input light 108 to the output light 110 is via luminescence that occurs in the phosphor material.

Conversion performed by the light converter 122 may result in the output light 110 having one or more different characteristics from the input light 108. For example, the input light 108 may have a first set of wavelengths and a first radiant power. The light converter 122 is configured to convert the input light 108 to the output light 110 having a second set of wavelengths and/or a second radiant power. The second set of wavelengths may be different or include at least one different wavelength than the first set of wavelengths. Additionally, the second radiant power may be different from the first radiant power.

The input light 108 may include a curing light emitted from one or more light emitting diodes (LEDs) 154. The input light 108 emitted from the curing light may include blue light, violet light, ultraviolet light, or some combination thereof. For instance, the input light 108 may include the first set of wavelengths in a wavelength range of about 385 nanometers (nm) to about 515 nm, in a wavelength range of about 440 nm to about 480 nm, in a wavelength range of about 395 nm to about 480 nm, or in another wavelength range suitable for polymerizing dental materials or performance of another dental process. Additionally or alternatively, the input light 108 may include a first radiant power in a power range of about 950 milliwatt (mW) to about 1150 mW, in a power range of about 1000 mW to about 1100 mW, in another suitable power range, having a radiant power of about 1067 mW, or having another suitable radiant power.

As discussed above, the output light 110 is substantially white light. In addition, the light converter 122 may include a phosphors matrix configured such that the output light 110 includes a correlated color temperature (CCT) between about 5400 Kelvins (K) to about 5600 K. The output light 110 may accordingly have a CCT that approximates or simulates daylight, which may result in the output light 110 being effective for inspection within a mouth of a patient.

Modifications, additions, or omissions may be made to the first assembly 100, the second assembly 300, the first optical converter 200, the second optical converter 400, or some combination thereof without departing from the scope of the present disclosure. For example, the first assembly 100 may include any number of the described devices. Moreover, the separation of various components in the embodiments described herein is not meant to indicate that the separation occurs in all embodiments.

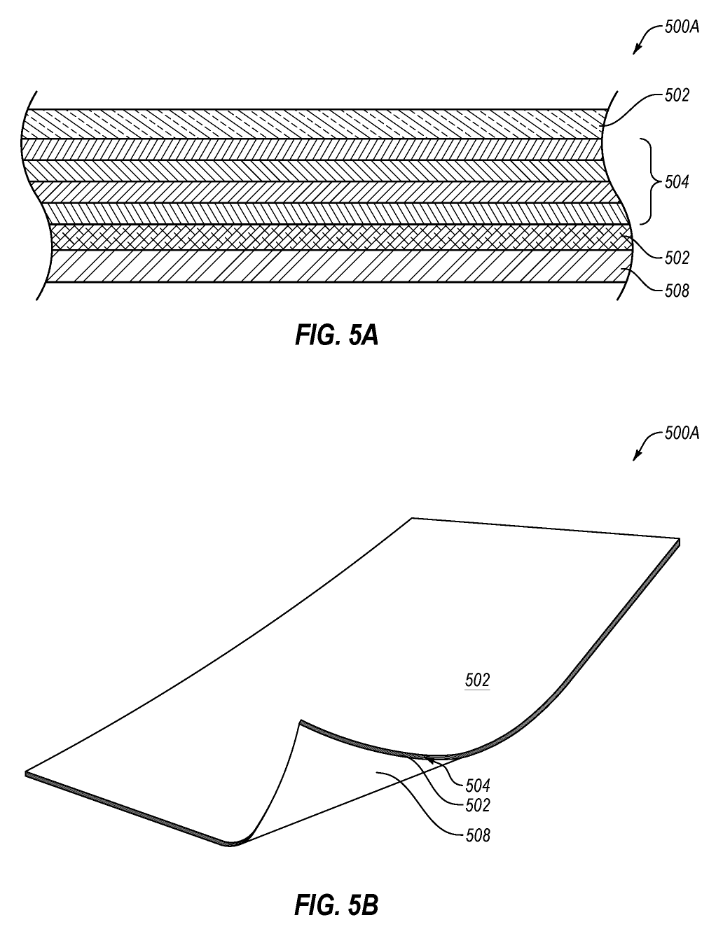

FIGS. 5A-5D illustrate example light converters 500A and 500B. For example, the light converters 500A and 500B may be implemented as the light converter 122 described with reference to FIGS. 1-4. FIGS. 5A and 5B depict a first example light converter 500A. The first light converter 500A is an example of an adhesive phosphors lamination. FIGS. 5C and 5D depict a second example light converter 500B. The second light converter 500B is an example of a diffused phosphor lamination. The first and second light converters 500A and 500B are collectively referred to as light converters 500.

The light converters 500 are laminations of one or more layers or substrates of material. For instance, the light converters 500 may include one or more support substrates 502. The support substrates 502 may include a polymer sheet, which may be comprised at least partially of polyethylene terephthalate (PET) or another suitable polymer. The polymer sheet may make the light converters 500 flexible, which may enable assembly of the light converters 500. For instance, the light converters 500 may be introduced into the housing 120 (of FIG. 1) after the securing mechanism 112 is attached to the housing 120.

The light converters 500 may also include one or more phosphor materials, such as in a phosphors matrix 504. The phosphors matrix 504 may be positioned on one or both of the support substrates 502. For instance, the phosphors matrix 504 may be painted or otherwise disposed on the support substrates 502 and/or may be encapsulated between the support substrates 502.

In response to the phosphors matrix 504 receiving input light (e.g., 108 of FIGS. 1-4), the phosphors matrix 504 may emit an output light (e.g., 110 of FIGS. 1-4) via luminescence. The input light may include blue light, violet light, ultraviolet light, or some combination thereof and the output light may be a white light. The light converters 500 may also attenuate radiant power of the input light. For example, the radiant power of the output light may be about one-sixth of the radiant power of the input light. For instance, the input light may include a radiant power in a range of about 1000 mW to about 1100 mW, e.g., about 1067 mW. The output light may include a radiant power in a range of about 130 mW to about 180 mW, e.g., about 173 mW.

The first light converter 500A of FIGS. 5A and 5B includes an adhesive layer 508. The adhesive layer 508 may enable attachment of the first light converter 500A to a surface. For instance, in the embodiment of FIGS. 3 and 4, the light converter 500A, which may correspond to light converter 122, is adhered to the surface 429 of the lens element 404.

The second light converter 500B of FIGS. 5C and 5D includes a diffusion layer 506. The diffusion layer 506 may spread or diffuse the output light. For instance, in the embodiment of FIGS. 1 and 2, the light converter 500B, which may correspond to light converter 122, may diffuse the output light 110 as it exits the first optical converter 200.

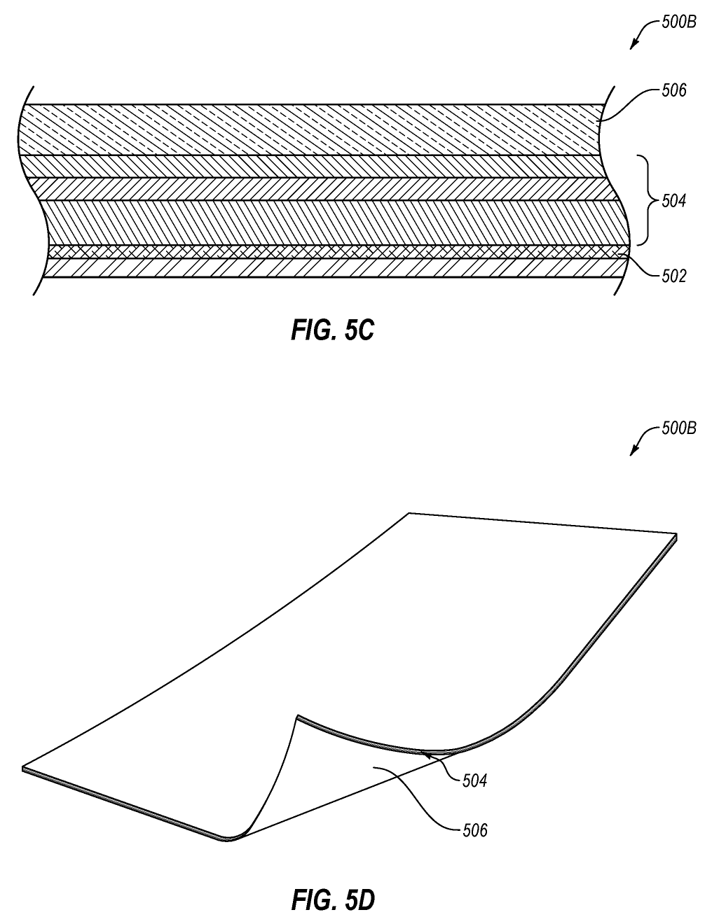

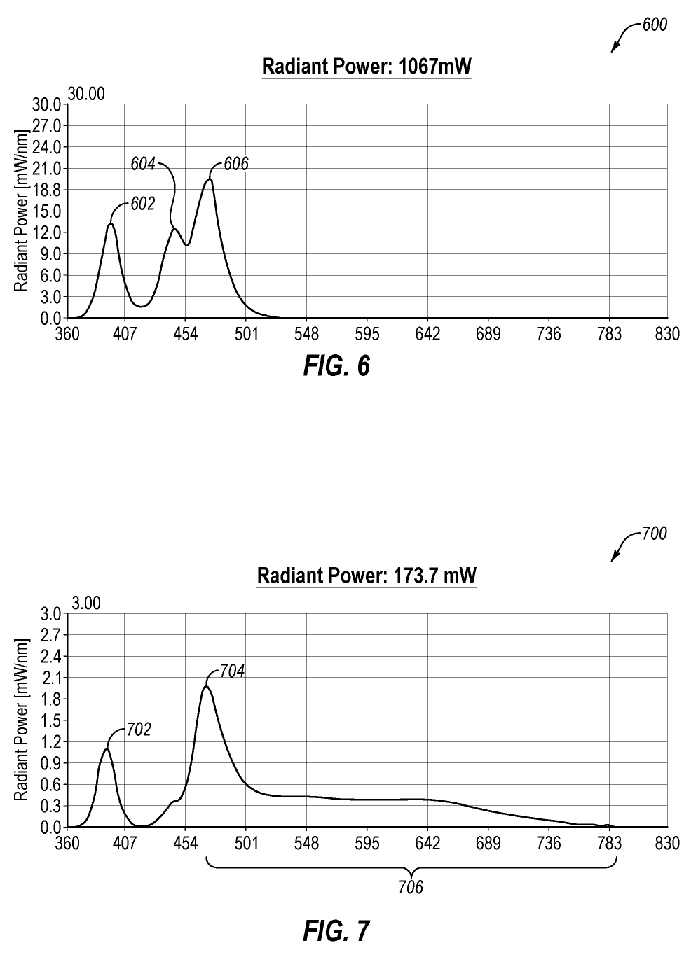

FIGS. 6-9 are example plots 600, 700, 800, and 900 that represent color power spectra. The plots 600, 700, 800, and 900 illustrate a radiant power of a light as a function of wavelength. FIG. 6 depicts a first plot 600. The first plot 600 depicts a relationship between radiant power and wavelength of input light such as the input light 108. The first plot 600 is representative of an input light that is generated and output by a VALO® curing light. FIGS. 7-9 depicts plots 700, 800, and 900 that depict example relationships between radiant power and wavelength of output light such as the output light 110. The output lights of FIGS. 7-9 may be output by the light converters such as light converters 122, 500A, and 500B described above. Each of the plots 600, 700, 800, and 900 are described below.

FIG. 6 illustrates the first plot 600. The first plot 600 depicts a relationship between radiant power and wavelength of input light such as the input light 108. In the first plot 600, the y-axis represents radiant power in milliWatt per nanometer (mW/nm). The x-axis represents wavelengths in nm. The scale of the radiant power is from 0 to 30 mW/nm. The scale of the wavelengths is from 360 to 830 nm. The first plot 600 of the input light may be emitted from a set of LEDs. The input light may include three peaks 602, 604, and 606. The first peak 602 is at about 405 nm, a second peak 604 is at about 440 nm, and a third peak 606 is at about 460 nm. In other embodiments, other peaks may occur depending on the curing light and/or LEDs included therein. The radiant power of the input light depicted in FIG. 6 is about 1067 mW.

FIG. 7 illustrates a second plot 700. The second plot 700 depicts a relationship between radiant power and wavelength of output light such as the output light 110 described elsewhere in the present disclosure. The output light plotted in FIG. 7 results from impingement of input light of FIG. 6 on the light converters (e.g., 122, 500A, or 500B). In the second plot 700, the y-axis represents radiant power in mW/nm. The x-axis represents wavelengths in nm. The scale of the radiant power is from 0 to 3 mW/nm. The scale of the wavelengths is from 360 to 830 nm. The output light may include two peaks 702 and 704 and a blended spectrum 706. The first peak 702 is at about 405 nm, which may be about the same as the first peak 602 of the first plot 600. The first peak 702 in the second plot 700 has a smaller radiant power than the first peak 602 of the plot 600. The second peak 704 is at about 460 nm, which is similar to the third peak 606 of the plot 600. The second peak 704 of the second plot 700 includes a lower radiant energy than the third peak 606 of the first plot 600. The blended spectrum 706 includes wavelengths that are greater than about 460 nm. For instance, in a wavelength range between about 501 nm and about 642 nm, the radiant power may be in a range of about 0.35 and about 0.5 mW/nm. The radiant power of the output light depicted in FIG. 7 is about 173 mW, which is about one-sixth of the radiant power of the input light of FIG. 6.

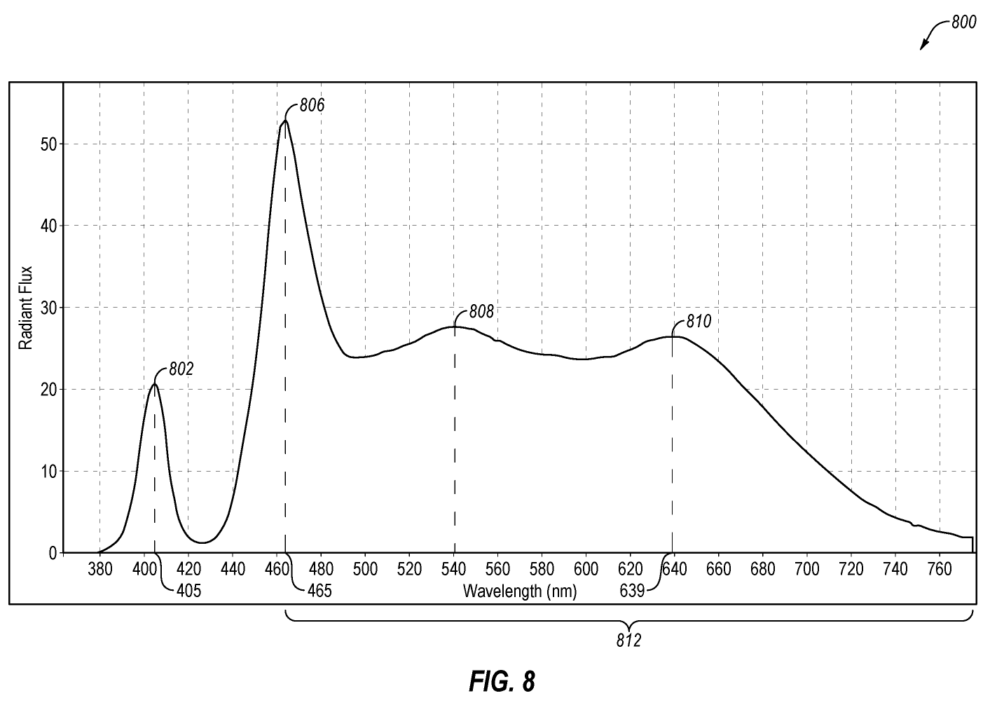

FIG. 8 is a third plot 800 of an example phosphor report. The phosphor report may be generated from the first light converter 500A that omits includes a diffuser layer (e.g., 506 of FIG. 5) based on input light that may be represented by the first plot 600 of FIG. 6. The phosphor report may be generated by measuring characteristics of output light (e.g., 110 of FIGS. 1-4) that is generated by the first light converter 500A. For instance, an input light may be received by the first light converter 500A. The first light converter 500A may convert the input light to an output light that is represented by the third plot 800 in the phosphor report.

In the third plot 800, the y-axis represents the radiant power and the x-axis of the third plot 800 represents a wavelength in nanometers (nm). The third plot 800 illustrates that there may be a first peak 802 at about 405 nm and a second peak 806 at about 440 nm. The third plot 800 may also include smaller peaks 808 and 810 at about 540 nm and about 650 nm. The smaller peaks 808 and 810 may be included in a blended spectrum 812. The blended spectrum 812 may include wavelengths that are greater than about 460 nm.

In the depicted embodiment, the output light represented in the third plot 800 may have optical properties that include a CIEx value of about 0.3304, a CIEy value of about 0.3508, a relative brightness (%) of about 1.0, a color temperature in Kelvin (K) of about 5487, and a color rendering index (CRI) value of about 91.

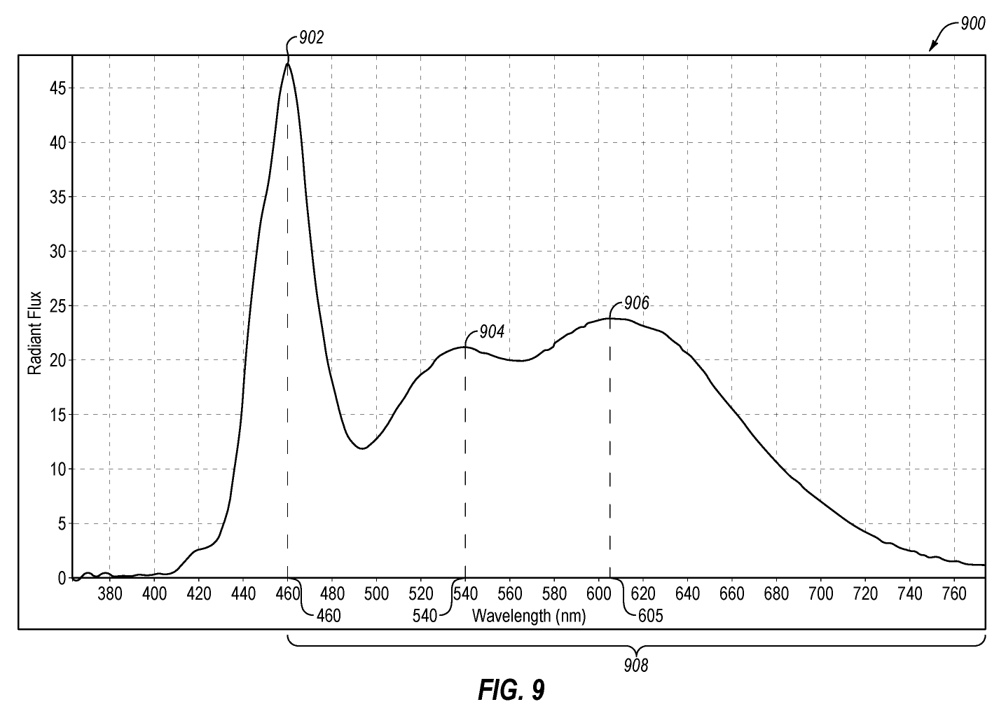

FIG. 9 is a plot 900 of an example phosphor report. The phosphor report may be generated using the second light converter 500B that includes a diffuser layer (e.g., 506 of FIG. 5). The phosphor report may be generated by measuring characteristics of output light (e.g., 110 of FIGS. 1-4) that is generated by the second light converter 500B. For instance, an input light may be received by the second light converter 500B. The second light converter 500B may convert the input light to an output light that is represented by the plot 900 in the phosphor report.

In the plot 900, the y-axis represents the radiant power and the x-axis of the plot 900 represents a wavelength in nanometers (nm). The plot 900 illustrates that there may be a first peak 902 at about 460 nm. The plot 900 may also include smaller peaks 904 and 906 at about 540 nm and about 620 nm. The smaller peaks 904 and 906 may be included in a blended spectrum 908. The blended spectrum 908 may include wavelengths that are greater than about 460 nm. In the depicted embodiment, the output light represented in the plot 900 may have optical properties that include a CIEx value of about 0.3330, a CIEy value of about 0.3138, a relative brightness (%) of about 1.0, a color temperature in Kelvin (K) of about 5460, and a color rendering index (CRI) value of about 92.

When compared to the third plot 800, the diffuser may shift the first peak 802 of the third plot 800. In particular, in the fourth plot 900 there is little radiant power around 405 nm. Additionally, the diffuser may lower the peaks 806 and 902 that occur at about 460 nm. For instance, in the third plot 800, the second peak 806 may be over about 50 mW/nm. In the fourth plot 900, the first peak 902 may have a radiant power over 45 mW/nm.

In some embodiments, the first light converter 500A and/or the second light converter 500B may include a RADIANT FLEX™ phosphor sheet. For example, the first light converter 500A and/or the second light converter 500B may include an RFS5500K RADIANT FLEX™ phosphor sheet.

Although this invention has been described in terms of certain preferred embodiments, other embodiments apparent to those of ordinary skill in the art are also within the scope of this invention. Accordingly, the scope of the invention is intended to be defined only by the claims, which follow.

What is claimed is:

1. An optical converter assembly comprising:
a housing that defines a first opening at a first end, the first opening being configured for receipt of a portion of a light-emitting portion of a dental curing light when the housing is selectively secured relative to the light-emitting portion of the dental curing light;
a securing mechanism that is configured to selectively retain the housing relative to the light-emitting portion; and
a light converter comprising a phosphor material, the light converter being secured relative to the housing such that an input light having a first set of wavelengths and a first radiant power emitted by the dental curing light is received by the light converter, wherein the light converter is configured to convert the input light to an output light having a second set of wavelengths and a second radiant power and to emit the output light that is substantially a white light.

2. The optical converter assembly of claim 1, wherein the input light includes a blue light and an ultraviolet light configured to polymerize a dental material.

3. The optical converter assembly of claim 2, wherein the first set of wavelengths of the input light includes wavelengths in a range of about 385 nanometers (nm) to about 515 nm.

4. The optical converter assembly of claim 2, wherein the first set of wavelengths of the input light includes wavelengths in a range of about 440 nanometers (nm) to about 480 nm.

5. The optical converter assembly of claim 2, wherein the first set of wavelengths of the input light includes wavelengths in a range of about 395 nanometers (nm) to about 480 nm.

6. The optical converter assembly of claim 1, wherein:
the first set of wavelengths of the input light includes a first peak at about 405 nanometers (nm), a second peak at about 440 nm, and a third peak at about 460 nm; and
the second set of wavelengths of the output light includes a first peak at 405 nm, a second peak at about 460 nm, and a blended spectrum with wavelengths greater than about 460 nm.

7. The optical converter assembly of claim 6, wherein the input light includes a radiant power of about 1067 milliwatt (mW) and the output light includes a second radiant power of about 173.7 mW.

8. The optical converter assembly of claim 7, wherein:
a phosphor material are arranged in a phosphors matrix; and
the light converter is constructed of a polymer sheet with the phosphors matrix disposed thereon.

9. The optical converter assembly of claim 1, wherein the output light includes a correlated color temperature between about 5400 Kelvins (K) to about 5600 K.

10. The optical converter assembly of claim 1, wherein the securing mechanism includes a magnetic element that is positioned within the housing, wherein the magnetic element is configured for magnetic retention of the housing relative to the light-emitting portion of the dental curing light.

11. The optical converter assembly of claim 10, wherein:
the housing defines a second opening at a second end which is opposite the first end;
the housing includes a conical portion that includes the second opening and a cylindrical portion that extends from the first end to the conical portion;
the magnetic element extends around a circumferential inner surface of the cylindrical portion; and
the light converter is positioned between the magnetic element and the second opening.

12. The optical converter assembly of claim 10, further comprising a lens element, wherein:
the lens element includes a conical portion and a cylindrical portion that is coupled to a first end of the conical portion;
the light converter is adhered to a surface of a second end of the conical portion;
the housing defines a second opening at a second end which is opposite the first end;
the housing includes a conical portion that includes the second opening and a cylindrical portion that extends from the first end to the conical portion; and
the magnetic element that extends around a circumferential inner surface of the cylindrical portion.

13. A dental instrument assembly comprising:
a dental curing light; and
the optical converter assembly of claim 1.

14. An optical converter assembly that is selectively secured relative to a dental curing light, the optical converter assembly comprising:
a housing that defines an internal volume between a first opening at a first end and a second opening at a second end, the first opening and a first portion of the internal volume being configured for receipt of a portion of a light-emitting portion of a curing light such that a curing light of the dental curing light is aligned with the first opening and the second opening;
a magnetic element that is positioned within the internal volume of the housing, wherein the magnetic element is configured for magnetic retention of the housing relative to the curing light of the dental curing light; and
a light converter that is positioned in the internal volume between the first opening and the second opening such that input light emitted from the curing light enters the internal volume and is received by the light converter,
wherein the light converter is constructed of a phosphors matrix including a plurality of phosphor particles that in response to receipt of the input light, emits an output light via luminescence that is a white light.

15. The optical converter assembly of claim 14, wherein:
the input light has a first set of wavelengths that includes a first wavelength of about 405 nanometers (nm), a second wavelength of about 440 nm, and a third wavelength of about 460 nm;
the output light has a second set of wavelengths that includes a first wavelength of about 405 nm and a second wavelength of about 460 nm; and
the third wavelength of the input light is converted to a blended spectrum above about 460 nm.

16. The optical converter assembly of claim 15, wherein:
the input light has a first radiant power of about 1067 milliwatt (mW); and
the light converter attenuates the first radiant power such that the output light has a radiant power of about 173.7 mW.

17. The optical converter assembly of claim 14, wherein:
the input light includes one or more wavelengths a range of about 385 nanometers (nm) to about 515 nm; a range of about 440 nm to about 480 nm; or a range of about 395 nm to about 480 nm; and
the output light includes a correlated color temperature between about 5400 Kelvins (K) to about 5600 K.

18. The optical converter assembly of claim 14, wherein the light converter is constructed of the phosphors matrix encapsulated between polymer sheets.

19. The optical converter assembly of claim 14, further comprising a lens element that is partially positioned in the housing, wherein:
the lens element includes a conical portion and a cylindrical portion that is coupled to a first end of the conical portion;
the light converter is adhered to a surface of a second end of the conical portion; and
the output light is directed by the cylindrical portion.

20. The optical converter assembly of claim 14, wherein:
the housing includes a conical portion that includes the second opening and a cylindrical portion that extends from the first end to the conical portion; and
the magnetic element includes a magnetic ring that extends around a circumferential inner surface of the cylindrical portion.
